(19) United States
(12) Patent Application Publication
(10) Pub. No.: US 2014/0342131 A1
(43) Pub. Date: Nov. 20, 2014

(54) CONDUCTIVE FILM AND FABRICATING METHOD THEREOF

(71) Applicant: Samsung Display Co., Ltd., Yongin-City (KR)

(72) Inventors: In-Nam Lee, Yongin-City (KR); Jeong-Heon Lee, Yongin-City (KR); Choon-Hyop Lee, Yongin-City (KR); Hak-Sun Kim, Yongin-City (KR)

(73) Assignee: Samsung Display Co., Ltd., Yongin-City (KR)

(21) Appl. No.: 13/895,200

(22) Filed: May 15, 2013

(51) Int. Cl. H01B 5/00; H01B 13/32

(52) U.S. Cl. CPC H01B 5/00; H01B 13/32
USPC 428/179; 264/104; 264/614; 264/105

(57) ABSTRACT

A conductive film includes an elastomer film having a concave-convex structure at a region thereof, and a conductive layer at a surface of the elastomer film and having a concave-convex structure at a region thereof.

### CROSS-REFERENCE TO RELATED APPLICATION

This application claims priority to and the benefit of Korean Patent Application No. 10-2013-0022085, filed on Feb. 28, 2013, in the Korean Intellectual Property Office, the entire disclosure of which is incorporated herein by reference.

### BACKGROUND

1. Field

Embodiments of the present disclosure relate to a conductive film and fabricating method thereof.

2. Description of the Related Art

Demand for flexible electronic devices, such as a flexible image display device or a flexible conductive film, has increased.

A conductive film may include a flexible film and a conductive layer coupled to the film. The conductive film is used for an electrode material of a flexible image display device or component packaging due to the flexible and elastic characteristics of the film, such that the range of uses thereof has been increased.

However, when a shape of the conductive film is deformed, the conductance of the conductive film changes. Particularly, density of a conductive layer is decreased by elongation between materials of the film and the conductive film in different rate in a region where the conductive film is stretched so as to rapidly increase resistance. Therefore, there are disadvantages of performance deterioration of electric and electronic products having the conductive film, and of improving power consumption efficiency.

### SUMMARY

According to an exemplary embodiment of the present invention, there is provided a conductive film including an elastomer film having a concave-convex structure at a region thereof, and a conductive layer at a surface of the elastomer film and having a concave-convex structure at a region thereof.

The conductive layer may include a conductive material, wherein a density of the conductive material at the region having the concave-convex structure may be greater than a density of the conductive material at an adjacent flat area of the conductive layer.

A shape of the concave-convex structure of the conductive layer may correspond to the concave-convex structure of the elastomer film.

The conductive layer may include conductive nano material.

The conductive layer may include a conductive material selected from one or more of nano wire, nano particle, carbon nano tube, and conductive polymer.

The concave-convex structure may include a polygonal wave concave-convex shape.

The concave-convex structure may include a triangle or tetragonal wave concave-convex shape.

The concave-convex structure may include a rounded concave part or a rounded convex part.

According to another embodiment of the present invention, a method for fabricating a conductive film may include preparing a substrate, patterning a surface of the substrate to form a concave-convex structure, forming a conductive layer comprising conductive material at the patterned surface of the substrate, forming an elastomer film by coating an elastomer material on the conductive layer, and separating the substrate from the conductive layer and the elastomer film.

The forming the conductive layer may include coating the surface of the substrate with the conductive material and sintering the conductive material.

The conductive layer may include a material selected from one or more of nano wire, nano particle, carbon nano tube, and conductive polymer.

A density of the conductive material at a region corresponding to the concave-convex structure may be higher than a density of the conductive material at an adjacent flat area of the conductive layer.

The conductive layer may have a concave-convex shape corresponding to the concave-convex structure of the substrate.

Forming the elastomer film may include coating the conductive layer with the elastomer material, and curing the conductive layer to cause the elastomer film to have a concave-convex structure.

The elastomer film may include a region having a concave-convex shape corresponding to the concave-convex structure of the substrate.

### BRIEF DESCRIPTION OF THE DRAWINGS

The accompanying drawings, together with the specification, illustrate example embodiments of the present disclosure, and together with the description, serve to explain aspects of the present invention.

FIG. 1 is a cross-sectional view showing a conductive film according to an embodiment of the present disclosure;

FIGS. 2A to 2E are cross-sectional views showing a fabricating method for the conductive film of the embodiment shown in FIG. 1;

FIG. 3 is a cross-sectional view showing a conductive film according to another embodiment of the present disclosure;

FIG. 4 is a cross-sectional view showing a conductive film according to another embodiment of the present disclosure; and

FIGS. 5A and 5B are cross-sectional views of an application of the example embodiments of the present disclosure.

### DETAILED DESCRIPTION

In the following detailed description, example embodiments of the present disclosure have been shown and described by way of illustration. Those skilled in the art would appreciate that the described embodiments may be modified in various ways without departing from the spirit or scope of the present disclosure. Accordingly, the drawings and description are to be regarded as illustrative in nature, and not restrictive. When an element is referred to as being “on” another element, it can be directly on another element, or can be indirectly on another element with one or more intervening elements interposed therebetween. When an element is referred to as being “connected to” another element, it can be directly connected to another element, or can be indirectly connected to another element with one or more intervening elements interposed therebetween. Hereinafter, like reference numerals refer to like elements.

Hereinafter, various embodiments of the present disclosure will be described in detail with reference to the accompanying drawings.

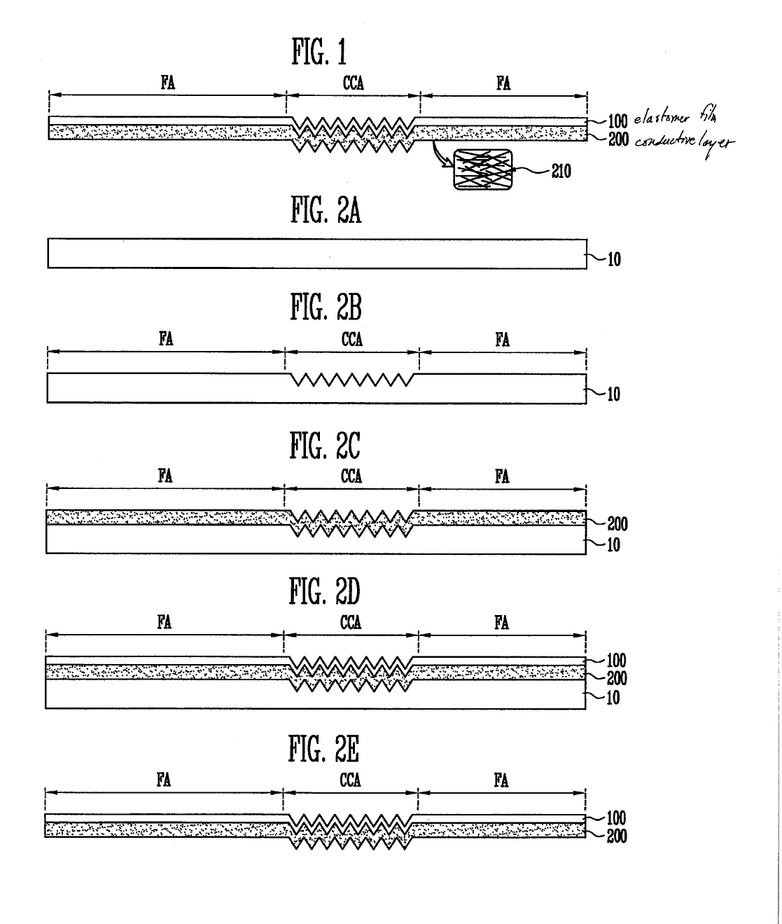

FIG. 1 is a cross-sectional view showing a conductive film according to an embodiment of the present disclosure.

Referring to FIG. 1, the conductive film according to the present disclosure includes an elastomer film 100 and a conductive layer 200 formed on at least one surface of the elastomer film 100.

The elastomer film 100 may be patterned to have a concave-convex structure on at least one surface, for example, and may include a concave-convex area CCA having a triangular (e.g., zigzag patterned) concave-convex structure, and a flat area FA that is a flat region adjacent to the concave-convex area CCA. The concave-convex area CCA may be implemented at a region where a shape deformation is expected (e.g., where the elastomer film 100 and the conductive layer 200 are to be bent or folded). The elastomer film 100 may serve to provide high flexibility and elasticity due to the characteristic of the material thereof.

The conductive layer 200 includes the concave-convex area CCA and is also formed at, at least one surface of the elastomer film 100. Therefore, the conductive layer 200 may also include the concave-convex area CCA and a flat area FA adjacent thereto.

Although the conductive layer 200 is formed on one surface of the elastomer film 100 according to the present embodiment, the present disclosure is not limited thereto. By way of example, the conductive layer 200 may be formed on both surfaces of the elastomer film 100.

The conductive layer 200 of the present embodiment includes a conductive material, such as a conductive nano material 210. For example, the conductive layer 200 may be configured to include at least a nano wire, nano particle, carbon nano tube and/or a conductive polymer.

The conductive layer 200 may be implemented to include the conductive nano material 210 having a density that is greater than the density of the adjacent flat area FA. Many conductive materials are coated due to the characteristic of the concave-convex area CCA, such as with the conductive nano material 210.

When the conductive nano material 210 has a higher density in the concave-convex area CCA, a rapid resistance voltage increase (e.g., an increase in electrical resistance or in voltage drop) is prevented in the region where the shape deformation is generated, for example, in the stretched concave-convex area. Therefore, the resistance increase due to the shape deformation of the conductive film may be reduced, and the consumption power (e.g., the power efficiency) may be improved.

The size of the concave-convex structure formed at the concave-convex area CCA, for example, a length, a width, a depth, a gap between pitches, may be configured according to the subject or the object for which the conductive film is applied. In addition, the thickness of the conductive layer 200 may be improved according to design specifications in consideration of the desired optical characteristic, such as a transmissivity or haze, and conductance.

FIGS. 2A to 2E are cross-sectional views showing a method for fabricating the conductive film of the embodiment shown in FIG. 1.

Referring to FIGS. 2A to 2E, a fabrication method for the conductive film of the embodiment shown in FIG. 1 will be described sequentially. The method for fabricating the conductive film includes: preparing a substrate 10; patterning the substrate 10 to have a concave-convex structure formed on at least one surface thereof; forming the conductive layer 200 after coating the conductive material onto one surface of the substrate 10 that is patterned to have the concave-convex structure; forming an elastomer film 100 after coating an elastomer material onto the conductive layer 200; and separating the conductive film, which includes the conductive layer 200 and the elastomer film 100, from the substrate 10.

In more detail, as shown in FIG. 2A, the substrate 10 (e.g., a glass or Si/SiO2 substrate 10), is prepared.

As shown in FIG. 2B, the substrate 10 is patterned to have a concave-convex structure formed on one surface thereof. Various patterning methods such as photolithography, dry etching and/or wet etching may be selectively used for the patterning of the substrate 10. The size of concave-convex structure, such as the shape, width, depth, and gap between pitches, may be determined according to the type or design of the object.

When the substrate 10 is patterned, the substrate 10 includes the concave-convex area CCA and the adjacent flat area FA. Here, a space ratio of the concave-convex area CCA and the flat area FA may be determined according to the intended application of the object or design of the object. For example, a space of the concave-convex area CCA may be determined to be in a range of 10% to 90% of the entire space of the substrate.

As shown in FIG. 2C, the conductive material is applied on the substrate 10 patterned to have a concave-convex structure, and the conductive layer 200 is formed. For example, the conductive material is thinly coated on one surface of the patterned substrate 10 by spin coating, bar coating, or spray coating, and the conductive layer 200 is formed through sintering. Then, a thicker conductive material is coated, and the higher conductance is secured. However, it decreases an optical transmittance and increases haze such that the thickness of the conductive layer 200 may be chosen according to the intended application of the relevant subject matter or design of the object.

At least one material may be used as the conductive material, such as nano wire, nano particle, carbon nano tube, and/or a conductive polymer. According to the characteristics of the concave-convex area CCA, more conductive material gathers at the concave-convex area CCA so the density of the conductive material is higher at the concave-convex CCA than at the flat area FA.

Since the conductive material is coated along the shape of lower substrate 10, the conductive layer 200 is patterned to include a concave-convex shape corresponding to the concave-convex structure of the concave-convex area CCA (e.g., corresponding to the region having a concave-convex structure).

As shown in FIG. 2D, the elastomer film 100 is mounted on the conductive layer 200. After the elastomer material is coated onto the conductive layer 200, the elastomer film 100 may be formed by a heat or UV curing processes. The elastomer material may be coated corresponding to a desired thickness according to the intended application of the object, the subject matter of the object, or the design of the object.

When the elastomer film 100 is formed by curing the elastomer material, the conductive layer 200 is cured to be formed on one surface of the elastomer film 100 to also form a concave-convex shape corresponding to a concave-convex structure which is implemented on the concave-convex area CCA having the shapes of the lower substrate 10 and the conductive layer 200.

The conductive film configured with the conductive layer 200 and the elastomer film 100 is separated from the substrate 10 so that the conductive film shown in FIG. 2E is manufactured. Since the conductive film is cured, it may be separated from the substrate 10.

Although an example of forming a triangular wave (e.g., zigzag patterned) concave-convex structure is disclosed in FIGS. 1 to 2E, the embodiments of the present disclosure are not limited thereto, and the shapes of concave-convex structure may be varied.

For example, the concave-convex structure may be implemented to have a polygonal concave-convex shape such as a tetragonal concave-convex shape.

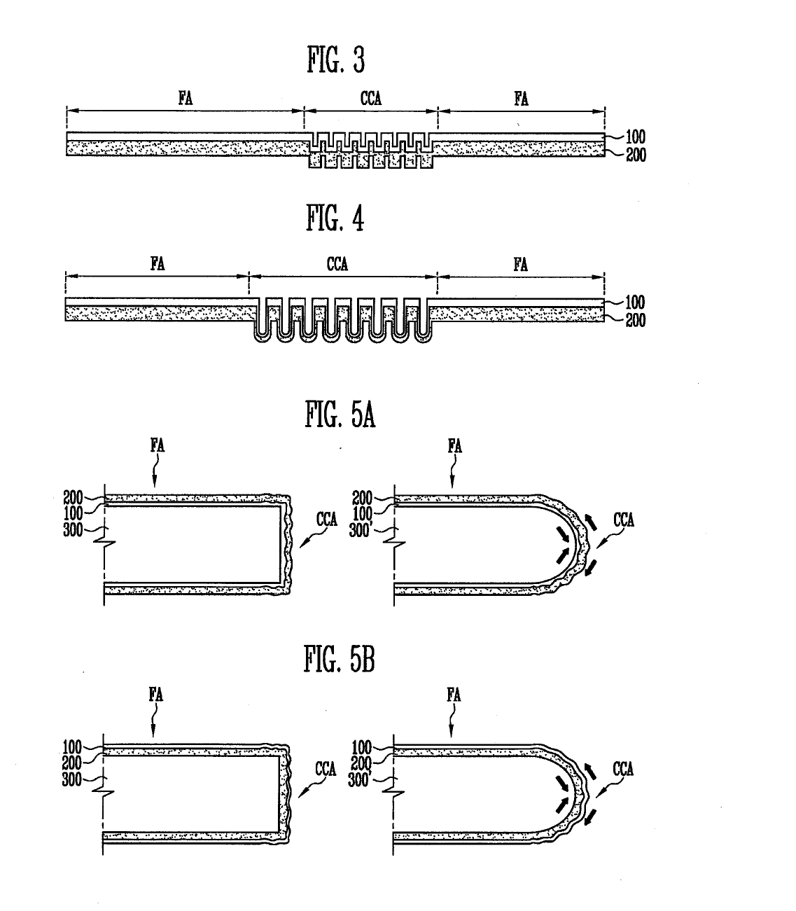

The concave-convex structure of the concave-convex area CCA is not limited to having a polygonal concave-convex shape. For example, the concave-convex area CCA may have a concave-convex shape with a rounded concave part or a convex part. For example, the concave-convex structure may be implemented to have a concave part having a rounded lower end, as shown in FIG. 4.

The concave-convex area CCA of embodiments of the present invention is implemented to have various shapes of concave-convex structure, some of which are shown in FIGS. 3 and 4. The components in FIGS. 3 and 4 that are same as, or similar to, those of FIG. 1 will be denoted by the same reference numerals.

FIGS. 5A and 5B are cross-sectional views of an application of the embodiment of the present disclosure described above.

Referring to FIGS. 5A to 5B, the conductive film according to the embodiments of the present disclosure may be used for component packaging of electric/electronic products, for example, to implement bezel-free function of display panels 300 and 300′.

Since the conductive film is highly flexible and elastic, the conductive film may be used to surround an inner and outer side of a three-dimensional structure, such as display panels 300 and 300′. The conductive film may be used to stably surround the display panel 300 configured to have an angular end portion, or the display panel 300′ configured to have a rounded end portion, regardless of the shape of the three-dimensional structure.

Because the concave-convex area CCA of the conductive film 200 is located at a region where shape deformation is generated, and the density of the conductive material is configured to be greater than that of the flat area FA. Thus, a local resistance increase at regions where the shape deformation is generated may be reduced or minimized, even though the conductive layer 200 is located outside and is extended, as shown in FIG. 5A.

In some embodiments, the conductive layer 200 is located at an inner side of the conductive layer 200 and is contracted, as shown in FIG. 5B. The density of the conductive material is increased in the concave-convex area CCA, and a resistance decrease is generated so that power consumption may be improved.

An example of using the conductive film for components packaging of electric/electronic products is disclosed in FIGS. 5A to 5B, however, the present invention is not limited thereto. For example, the conductive film may be used for the electrode material of a flexible image display device or a touch screen panel. Accordingly, conductance characteristics may be stabilized when shape deformation occurs. The conductive film may also be used in various fields, such as a conductive interconnector.

As set forth above, the conductive film and a method for fabricating the conducting film according to various embodiments of the present invention are described. The conducting film may be fabricated by patterning to have the concave-convex structure on at least one region thereof, and forming the conductive material at the concave-convex structure to have a density that is higher than that of the adjacent area. The resistance increase due to deformation of the conductive film can be reduced minimized and a rate of power consumption can be improved.

While embodiments of the present invention have been described in connection with certain example embodiments, it is to be understood that the present invention is not limited to the described embodiments, but is instead intended to cover various modifications and equivalent arrangements included within the spirit and scope of the appended claims, and equivalents thereof.

What is claimed is:

1. A conductive film comprising:
an elastomer film having a concave-convex structure at a region thereof; and
a conductive layer at a surface of the elastomer film and having a concave-convex structure at a region thereof.

2. The conductive film according to claim 1, wherein the conductive layer comprises a conductive material, a density of the conductive material at the region having the concave-convex structure being greater than a density of the conductive material at an adjacent flat area of the conductive layer.

3. The conductive film according to claim 1, wherein a shape of the concave-convex structure of the conductive layer corresponds to the concave-convex structure of the elastomer film.

4. The conductive film according to claim 1, wherein the conductive layer comprises conductive nano material.

5. The conductive film according to claim 1, wherein the conductive layer comprises a conductive material selected from the group consisting of nano wire, nano particle, carbon nano tube, and conductive polymer.

6. The conductive film according to claim 1, wherein the concave-convex structure comprises a polygonal wave concave-convex shape.

7. The conductive film according to claim 6, wherein the concave-convex structure comprises a triangle or tetragonal wave concave-convex shape.

8. The conductive film according to claim 1, wherein the concave-convex structure comprises a rounded concave part or a rounded convex part.

9. A method for fabricating a conductive film comprising:
preparing a substrate;
patterning a surface of the substrate to form a concave-convex structure;
forming a conductive layer comprising conductive material at the patterned surface of the substrate;
forming an elastomer film by coating an elastomer material on the conductive layer; and
separating the substrate from the conductive layer and the elastomer film.

10. The method for fabricating a conductive film according to claim 9, wherein the forming the conductive layer comprises coating the surface of the substrate with the conductive material and sintering the conductive material.

11. The method for fabricating a conductive film according to claim 9, wherein the conductive layer comprises a material selected from the group consisting of nano wire, nano particle, carbon nano tube, and conductive polymer.

12. The method for fabricating a conductive film according to claim 9, wherein a density of the conductive material at a region corresponding to the concave-convex structure is higher than a density of the conductive material at an adjacent flat area of the conductive layer.

13. The method for fabricating a conductive film according to claim 9, wherein the conductive layer has a concave-convex shape corresponding to the concave-convex structure of the substrate.

14. The method for fabricating a conductive film according to claim 9, wherein the forming the elastomer film comprises:
coating the conductive layer with the elastomer material; and
curing the conductive layer to cause the elastomer film to have a concave-convex structure.

15. The method for fabricating a conductive film according to claim 9, wherein the elastomer film comprises a region having a concave-convex shape corresponding to the concave-convex structure of the substrate.
